(19) United States
(12) Patent Application Publication
(10) Pub. No.: US 2007/0076895 A1
(43) Pub. Date: Apr. 5, 2007

(54) AUDIO PROCESSING SYSTEM AND METHOD FOR HEARING PROTECTION

(75) Inventors: Xiao-Guang Li, Shenzhen (CN); Kuan-Hong Hsieh, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/309,449

(22) Filed: Aug. 8, 2006

(30) Foreign Application Priority Data
Sep. 5, 2005 (TW) 094130297

(51) Int. Cl. H04R 29/00; H04R 25/00

(52) U.S. Cl. 381/56; 381/321

(57) ABSTRACT

The present invention relates to an audio processing method for hearing protection, includes steps of: obtaining analog audio signals amplified according to a current gain value; converting the analog audio signals obtained to digital audio signals; sampling the digital audio signals thereby obtaining a plurality of amplitude values mi; calculating an accumulated audio energy during a predetermined time interval by sampling amplitude values in the predetermined time interval; determining whether the accumulated audio energy reaches a predetermined value; and automatically reduce the current gain value or outputting a prompt signal to prompt a user to manually reduce the current gain value when the accumulated audio energy value reaches a predetermined value; whereby protecting users' hearing. The present invention also provides a corresponding audio processing system for hearing protection.

### TECHNICAL FIELD

The present invention relates to an audio processing system and method for hearing protection, especially to an audio processing system and method for evaluating audio energy after outputting audio signals, and automatically adjusting a current gain value or outputting a prompt signal according to the evaluated audio energy.

### GENERAL BACKGROUND

The continuous development of new digital technology has helped portable audio devices (such as MP3 player) become popular among people. When environmental noise external of the portable audio device is loud or when a favorite song is played, a user commonly increases a volume of a portable device. However users all have a physiological hearing threshold, i.e., loudness discomfort level (LDL). If the user is exposed to an environment with a noise volume level that is larger than the user's LDL for a long time, the user's hearing may be damaged.

In order to solve the problems mentioned, there is a common gain control system and method available in the market. The gain control system and method provides a gain value limit and forbids adjusting the gain value beyond the gain value limit. However, the system and method is rigid and not user friendly.

Therefore, a heretofore unaddressed need exists in the industry to overcome the aforementioned deficiencies and inadequacies.

### SUMMARY

In order to solve said problems, the present invention provides an audio processing system and method for protecting users' hearing.

The audio processing method for hearing protection includes steps of: obtaining analog audio signals amplified according to a current gain value V; converting the analog audio signals obtained to digital audio signals; sampling the digital audio signals thereby obtaining a plurality of amplitude values mi; calculating an accumulated audio energy Q during a predetermined time interval T by sampling amplitude values mi in the predetermined time interval T; determining whether the accumulated audio energy Q reaches a predetermined value K; and generating a hearing protection signal if the accumulated audio energy Q reaches a predetermined value K.

The audio processing system for hearing protection includes a processing unit, a gain control unit, an analog/digital converter and a gain management unit. The gain control unit amplifies analog audio signals received according to a current gain value V. The analog/digital converter obtains the analog audio signals amplified, and converts the analog audio signals obtained to digital audio signals. The gain management unit controlled by the processing unit, samples the digital audio signals received from the analog/digital converter thereby obtaining a plurality of amplitude values mi; calculates an accumulated audio energy Q during a predetermined time interval T by sampling amplitude values mi in the predetermined time interval T; determines whether the accumulated audio energy Q reaches a predetermined value K; and generates a hearing protection signal if the accumulated audio energy Q reaches a predetermined value K.

The audio processing system for hearing protection includes a processing unit, a gain control unit and an analog/digital converter. The gain control unit amplifies analog audio signals received according to a current gain value V. The analog/digital converter obtains the analog audio signals amplified, and converts the analog audio signals obtained to digital audio signals. The processing unit includes a sampling module for sampling the digital audio signals received from the analog/digital converter thereby obtaining a plurality of amplitude values mi; a calculating module for calculating an accumulated audio energy Q during a predetermined time interval T by sampling amplitude values mi in the predetermined time interval T; a detecting module for determining whether the accumulated audio energy Q reaches a predetermined value K; and generating a hearing protection signal if the accumulated audio energy Q reaches a predetermined value K.

Other systems, methods, features, and advantages will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

FIG. 1 is a block diagram of a hardware infrastructure of an audio processing system for hearing protection in accordance with a preferred embodiment of the present invention;

FIG. 2 is a schematic diagram of main function modules of a gain management unit of FIG. 1;

FIG. 3 is a common flowchart of playing an audio file;

FIG. 4 is a flowchart of a preferred audio processing method for hearing protection by utilizing the system of FIG. 1;

FIG. 5 is a block diagram of a hardware infrastructure of an audio processing system for hearing protecting in accordance with a second preferred embodiment of the present invention; and

FIG. 6 is a schematic diagram of main function modules of a processing unit of FIG. 5.

### DETAILED DESCRIPTION OF THE PREFERRED EMBODIMENTS

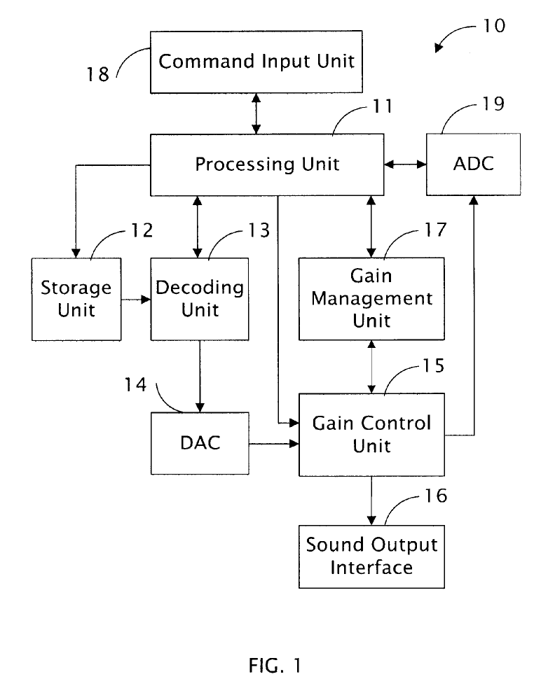

FIG. 1 is a block diagram of a hardware infrastructure of an audio processing system for hearing protection in accordance with a preferred embodiment of the present invention. The audio processing system 10 includes a processing unit 11, a storage unit 12, a decoding unit 13, a digital/analog converter (DAC) 14, a gain control unit 15, a sound output interface 16, a gain management unit 17, a command input unit 18, and an analog/digital converter (ADC) 19. The storage unit 12 stores a plurality of audio files, a current gain value V, and a decoding program. The storage unit 12 can be a flash storage, a hard disk driver, and the like. The processing unit 11 controls a plurality of the system 10 elements, i.e., the storage unit 12, the decoding unit 13, the gain control unit 15, the gain management unit 17 and the command input unit 18.

The command input unit 18 generates a command in response to an input selection of the user. The command includes a command for playing an audio file and a command for adjusting the current gain value V. The processing unit 11 fetches the audio file from the storage unit 12 in response to the command for playing the audio file.

The decoding unit 13 activates the decoding program stored in the storage unit 12, decodes the audio file fetched from the storage unit 12 and generates digital audio signals. The DAC 14 converts the digital audio signals from the decoding unit 13 to analog audio signals.

The gain control unit 15 amplifies the analog audio signals from the DAC 14 according to the current gain value V. The sound output interface 16 sends the analog audio signals amplified by the gain control unit 15 to an earphone or a speaker (not shown) being connected therein.

The analog/digital converter (ADC) 19 obtains the analog audio signals amplified by the gain control unit 15, converts the analog audio signals obtained to digital audio signals, and sends the digital audio signals to the gain management unit 17.

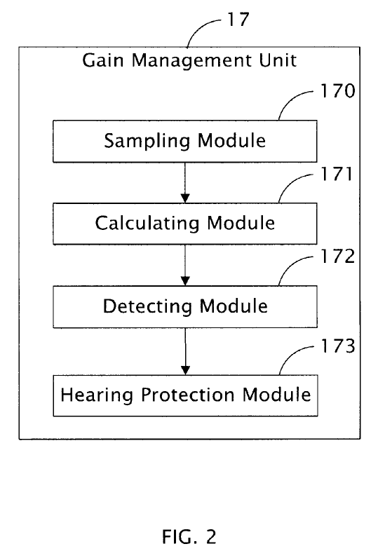

Reference to FIG. 2, the gain management unit 17 includes a sampling module 170, a calculating module 171, a detecting module 172, and a hearing protection module 173. The sampling module 170 receives the digital audio signals from the ADC 19, and samples the digital audio signals received thereby obtaining a plurality of amplitude values mi of the digital audio signals sampled.

The calculating module 171 calculates an accumulated audio energy Q during a predetermined time interval T by sampling amplitude values mi sampled in the predetermined time interval T, according to an algorithm. The algorithm is: Q=[Σ(mi)2/N]1/2, where i is any natural number, and N presents a count of the amplitude values mi sampled in the predetermined time interval T.

The detecting module 172 determines whether the accumulated audio energy Q reaches a predetermined value K; and if the accumulated audio energy Q reaches the predetermined value K, the detecting module 173 generates a hearing protection signal. The predetermined value K is an upper threshold allowable for a user's hearing.

The hearing protection module 173 controls the gain control unit 15 to automatically reduce the current gain value V to a reduced gain value V according to the hearing protection signal. Then, the gain control unit 15 amplifies the analog audio signals from the DAC 14 according to the reduced gain value V, and sends the analog audio signals amplified to the earphone or the speaker (not shown) via the sound output interface 16.

In other preferred embodiment, the hearing protection module 174 may generate a prompt signal to prompt a user to manually reduce the current gain value V according to the hearing protection signal. Then the gain control unit 15 amplifies the prompt signal, and sends the prompt signal amplified to the earphone or the speaker (not shown) via the sound output interface 16. Furthermore, the hearing protection module 174 may also directly send the prompt signal generated to the earphone or the speaker (not shown) via the sound output interface 16.

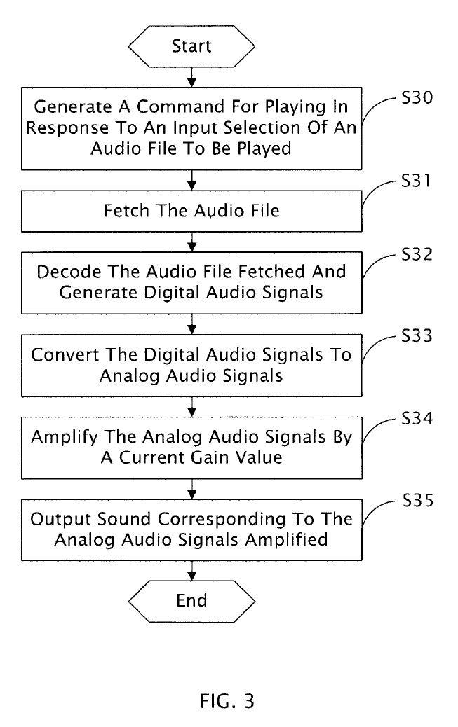

FIG. 3 is a common flowchart of playing an audio file. In step S30, the command input unit 18 generates the command for playing the audio file in response to the input selection of the audio file to be played. In step S31, the processing unit 11 fetches the audio file from the storage unit 12 in response to the command generated by the command input unit 18.

In step S32, the decoding unit 13 decodes the audio file fetched from the storage unit 12 and generates digital audio signals. In step S33, the DAC 14 converts the digital audio signals from the decoding unit 13 to analog audio signals.

In step S34, the gain control unit 15 amplifies the analog audio signals from the DAC 14 according to the current gain value V stored in the storage unit 12. In step S35, the sound output interface 16 outputs the analog audio signals amplified to the earphone or the speaker (not shown) being connected therein, and the earphone or the speaker thereupon outputs sound corresponding to the analog audio signals amplified.

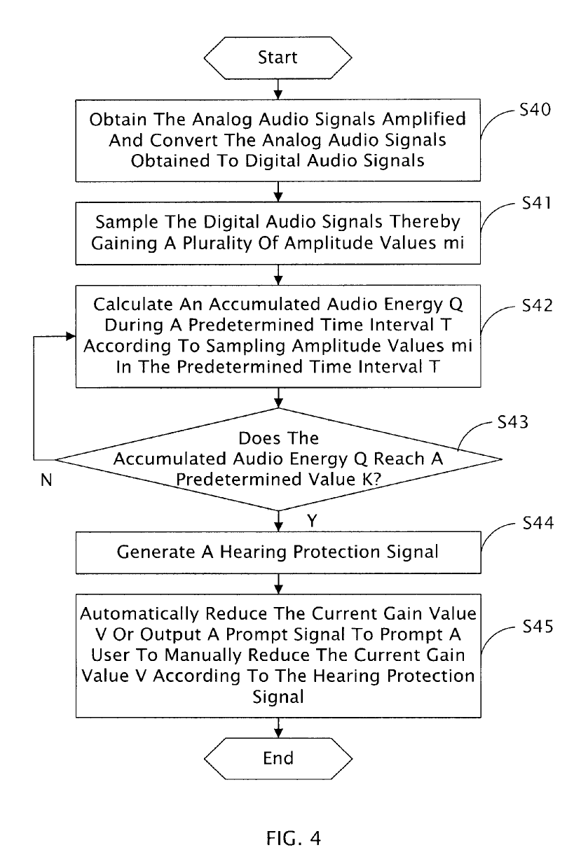

FIG. 4 is a flowchart of a preferred audio processing method for hearing protection by utilizing the system of FIG. 1. In step S40, the ADC 19 obtains the analog audio signals amplified by the gain control unit 15, converts the analog audio signals obtained to digital audio signals, and sends the digital signals to the gain management unit 17.

In step S41, the sampling module 170 receives the digital audio signals from the ADC 19, and samples the digital audio signals received thereby obtaining a plurality of amplitude values mi of the digital audio signals sampled.

In step S42, the calculating module 171 calculates the accumulated audio energy Q during the predetermined time interval T by sampling amplitude values mi in the predetermined time interval T.

In step S43, the detecting module 172 determines whether the accumulated audio energy Q reaches the predetermined value K, if the accumulated audio energy Q does not reach the predetermined value K, the procedure goes to step S42. If the accumulated audio energy Q reaches the predetermined value K, in step S44, the detecting module 172 generates the hearing protection signal.

In step S45, the hearing protection module 173 controls the gain control unit 15 to automatically reduce the current gain value V or outputs the prompt signal to prompt a user to manually reduce the current gain value V according to the hearing protection signal.

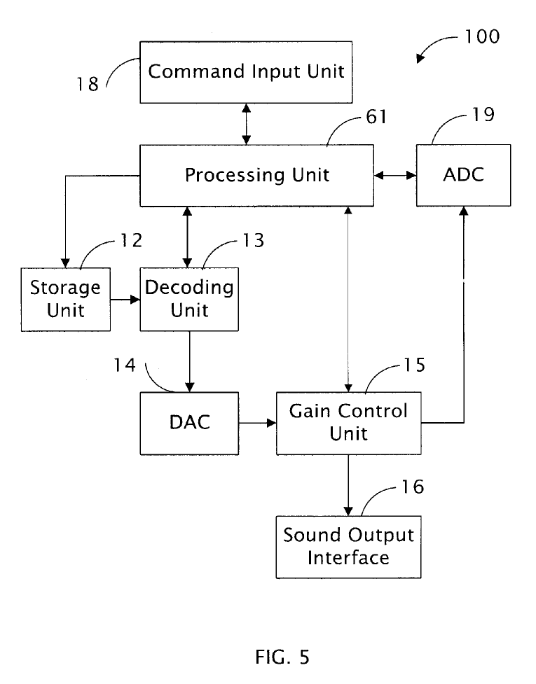

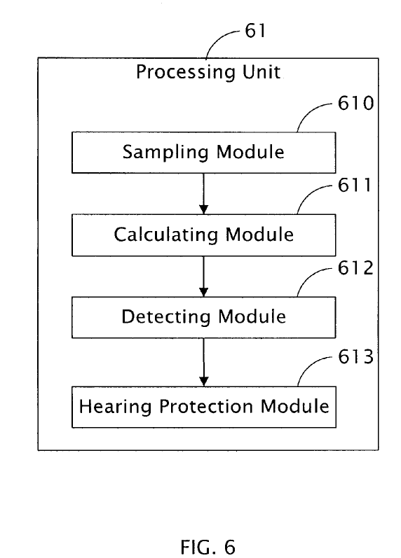

FIG. 5 is a block diagram of a hardware infrastructure of an audio processing system for hearing protecting in accordance with a second preferred embodiment of the present invention. The difference between the second preferred embodiment and the first preferred embodiment is that the audio processing system 100 of the second embodiment does not include the gain management unit 17 and a processing unit 61 performs the functions thereof. Referring to FIG. 6, the processing unit 61 includes a sampling module 610, a calculating module 611, a detecting module 612, and a hearing protection module 613, which respectively performs the same functions as the sampling module 170, the obtaining module 171, the detecting module 172, and the hearing protection module 173 of the gain management unit 17 in the first preferred embodiment.

It should be emphasized that the above-described embodiments, including preferred embodiments, are merely possible examples of implementations, and are set forth for a clear understanding of the principles of the invention. Many variations and modifications may be made to the above-described embodiments without departing substantially from the spirit and principles of the invention. All such modifications and variations are intended to be included herein within the scope of this disclosure and the present invention, and be protected by the following claims.

What is claimed is:

1. An audio processing method for hearing protection, the method comprising the steps of:
obtaining analog audio signals amplified according to a current gain value V;
converting the analog audio signals obtained to digital audio signals;
sampling the digital audio signals thereby obtaining a plurality of amplitude values mi;
calculating an accumulated audio energy Q during a predetermined time interval T by sampling amplitude values mi in the predetermined time interval T;
determining whether the accumulated audio energy Q reaches a predetermined value K; and
generating a hearing protection signal if the accumulated audio energy Q reaches the predetermined value K.

2. The audio processing method for hearing protection according to claim 1, further comprising the step of: automatically reducing the current gain value V according to the hearing protection signal.

3. The audio processing method for hearing protection according to claim 1, further comprising the step of: generating and outputting a prompt signal according to the hearing protection signal.

4. The audio processing method for hearing protection according to claim 1, wherein the accumulated audio energy Q is calculated according to an algorithm, and the algorithm is: Q=[Σ(mi)2/N]1/2, where i is any natural number, and N presents a count of the amplitude values mi sampled in the predetermined time interval T.

5. An audio processing system for hearing protection, the system comprising:
a processing unit for controlling the system elements;
a gain control unit for amplifying analog audio signals received according to a current gain value V;
an analog/digital converter for obtaining the analog audio signals amplified, and converting the analog audio signals obtained to digital audio signals; and
a gain management unit controlled by the processing unit, for sampling the digital audio signals received from the analog/digital converter thereby obtaining a plurality of amplitude values mi, calculating an accumulated audio energy Q during a predetermined time interval T by sampling amplitude values mi in the predetermined time interval T, determining whether the accumulated audio energy Q reaches a predetermined value K, and generating a hearing protection signal if the accumulated audio energy Q reaches a predetermined value K.

6. The audio processing system for hearing protection according to claim 5, wherein the gain management unit further automatically controls the gain control unit to reduce the current gain value V according to the hearing protection signal.

7. The audio processing system for hearing protection according to claim 5, wherein the gain management unit further generates a prompt signal according to the hearing protection signal.

8. The audio processing system for hearing protection according to claim 5, wherein the accumulated audio energy Q is calculated according to an algorithm, and the algorithm is: Q=[Σ(mi)2/N]1/2; where i is any natural number, and N presents a count of the amplitude values mi sampled in the predetermined time interval T.

9. An audio processing system for hearing protection, the system comprising:
a processing unit for controlling the system elements;
a gain control unit for amplifying analog audio signals received according to a current gain value V;
an analog/digital converter for obtaining the analog audio signals amplified, and converting the analog audio signals obtained to digital audio signals;
wherein the processing unit comprises:
a sampling module for sampling digital audio signals received from the analog/digital converter thereby obtaining a plurality of amplitude values mi;
a calculating module for calculating an accumulated audio energy Q during a predetermined time interval T by sampling amplitude values mi in the predetermined time interval T; and
a detecting module for determining whether the accumulated audio energy Q reaches a predetermined value K, and generating a hearing protection signal if the accumulated audio energy Q reaches the predetermined value K.

10. The audio processing system for hearing protection according to claim 9, wherein the processing unit further comprises a hearing protection module for automatically controlling the gain control unit to reduce the current gain value V according to the hearing protection signal.

11. The audio processing system for hearing protection according to claim 9, wherein the processing unit further comprises a hearing protection module for generating a prompt signal according to the hearing protection signal.

12. The audio processing system for hearing protection according to claim 9, wherein the accumulated audio energy Q is calculated according to an algorithm, and the algorithm is: Q=[Σ(mi)2/N]1/2; where i is any natural number, and N presents a count of the amplitude values mi sampled in the predetermined time interval T.
